(19) United States
(12) Patent Application Publication
(10) Pub. No.: US 2014/0183984 A1
(43) Pub. Date: Jul. 3, 2014

(54) RESIN-MOLDED ROTATING MACHINE

(71) Applicant: HITACHI, LTD., Tokyo (JP)

(72) Inventors: Kinya Kobayashi, Tokyo (JP); Hironori Matsumoto, Tokyo (JP)

(21) Appl. No.: 14/118,040

(22) PCT Filed: May 16, 2012
(86) PCT No.: PCT/JP2012/062461

§ 371 Date: Nov. 15, 2013

(30) Foreign Application Priority Data
May 19, 2011 (JP) 2011-111977

(51) Int. Cl. H02K 3/00

(52) U.S. Cl. CPC H02K 3/00
USPC 310/43

(57) ABSTRACT

In a motor that is molded with resin in part or as a whole, thermal expansion caused by temperature rise due to reduction in size and increase in output causes application of stress equal to or greater than fracture stress to the resin, thus generating cracks.

Therefore, according to the invention, in a resin-molded rotating machine, a part or the whole of a gap between plural mold resins molded in different places from each other is made of a material with a higher thermal conductivity and a lower Young's modulus than the mold resins, and these mold resins are bonded together mechanically or with an adhesive material, or are fastened by both these methods.

### TECHNICAL FIELD

The present application relates to a partly or entirely resin-molded rotating machine.

### BACKGROUND ART

A rotating machine has a structure in which a rotor 1 and a stator 2 which generate a mechanical rotational force from electric energy, a rotation axis 3 which is connected to the rotor 1 and transmits the generated rotational force to outside, and a bearing 4 supporting the rotation axis 3 are provided and accommodated inside a housing made up of a frame 5 and an end bracket 6, as shown in FIG. 1. As a result, entry of dust and particles from the outside air is prevented and a soundproofing effect is also achieved. Moreover, since an electric current flows through a stator winding 7 when the machine is driven, space insulation 8 is provided in order to secure insulation between the stator winding 7 and the frame 5 or the end bracket 6.

In view of the recent energy saving and resource saving trend, reduction in size and weight of the rotating machine is demanded. By optimizing the structure based on highly accurate three-dimensional electromagnetic field analysis, reduction in size and weight of the rotating machine is realized. Also, there are many reports that progress in material development technology improves the performance of the rotating machine, significantly contributing to reduction in size and weight. Among them, engineering plastics, used for industrial purposes since around 1970, draw attention as anew material replacing metal materials. As a result, application thereof to rotating machines is considered and rotating machines using resin in some of the components thereof are developed. As a result, the resin reinforces the insulation of the stator winding and plays the role of structure members, thereby achieving reduction in size and weight.

However, the radiation performance of resin generally is as low as approximately one over several tens to one over several hundreds of the radiation performance of a metal. Therefore, the application of resin is partial or limited to small-sized rotating machines with relatively little heat generation. Also, products, mainly servo motors, are available at present, but resin cannot be applied to rotating machines that need to operate continuously such as general-purpose motors. Therefore, in the application of resin to medium to large-sized rotating machines including general-purpose motors, it is essential to employ a new radiation structure for improving deterioration in radiation performance.

Under such circumstances, according to JP-A-2008-178256, a resin with high crack resistance is used for the stator and coil end part. Also, according to JP-A-2009-50048, a resin is formed in an irregular shape following the outer circumferential shape of the coil.

### CITATION LIST

### Patent Literature

PTL 1: JP-A-2008-178256

PTL 2: JP-A-2009-50048

### SUMMARY OF INVENTION

### Technical Problem

However, the motor in which the coil end is sealed with a mold resin has a problem that thermal expansion generated by temperature rise due to reduction in size and increase in output causes stress equal to or greater than fracture stress to be applied to the resin, thus generating cracks. In the above PTL 1, the resin with high crack resistance is expensive and crack restraining ability is limited in improving the resin material itself. In the above PTL 2, simply forming the resin in an irregular shape following the outer circumferential shape of the coil is not effective enough to have crack restraining ability.

### Solution to Problem

In order to solve the foregoing problems, in a resin-molded electrical rotating machine, a part or the whole of a gap between at least two mold resins molded in different places from each other is made of a material with a higher thermal conductivity and a lower Young's modulus than the mold resins, and the mold resins are bonded together mechanically or with an adhesive material.

Also, a part or the whole of an outer circumference of a motor or is a material with a higher thermal conductivity than the resin and made to contact with the material inside the gap. Alternatively, the insertion member between the split resins is made of a material that is adhesive to the resin, on one side or on both sides. Moreover, the material inside the gap is made up of a fluid material. Furthermore, silicone, graphite sheet and graphene are provided as components. In order to improve the strength of the mold resin, a filler having a maximum outer diameter of 100 nm or smaller in part or in entirety is included.

A resin produced by one-step molding is cut to manufacture the resin. Moreover, a crack is carved in the resin surface. Alternatively, the insertion member is made up of a partial discharge-resistant material. A screw is fastened from outside the motor.

### Advantageous Effect of Invention

According to the invention, generation of cracks in the resin due to thermal expansion can be restrained and thermal conductivity between the split resins can be increased.

### BRIEF DESCRIPTION OF DRAWINGS

FIG. 1 is a sectional view of a rotating machine for explaining a conventional rotating machine.

FIG. 2 is a sectional view of an end in the axial direction of a rotating machine for explaining an example of the invention.

FIG. 3 is a view explaining change in noise characteristics according to an example of the invention.

FIG. 4 is a sectional view of an end in the axial direction of the rotating machine for explaining an example of the invention.

FIG. 5 is a sectional view of the rotating machine for explaining an example of the invention.

FIG. 6 is a schematic view of the rotating machine for explaining an example of the invention.

FIG. 7 is a view of a material structure inside a gap for explaining an example of the invention.

FIG. 8 is a view of another material structure inside a gap for explaining an example of the invention.

FIG. 9 is a view of another material structure inside a gap for explaining an example of the invention.

FIG. 10 is a view of another material structure inside a gap for explaining an example of the invention.

FIG. 11 is a sectional view of another rotating machine for explaining an example of the invention.

FIG. 12 is a sectional view of an end in the axial direction of the rotating machine for explaining an example of the invention.

FIG. 13 is a sectional view of another rotating machine for explaining an example of the invention.

FIG. 14 is a sectional view of another rotating machine for explaining an example of the invention.

FIG. 15 is a sectional view of another rotating machine for explaining an example of the invention.

### DESCRIPTION OF EMBODIMENTS

Examples will be described hereinafter.

### EXAMPLE 1

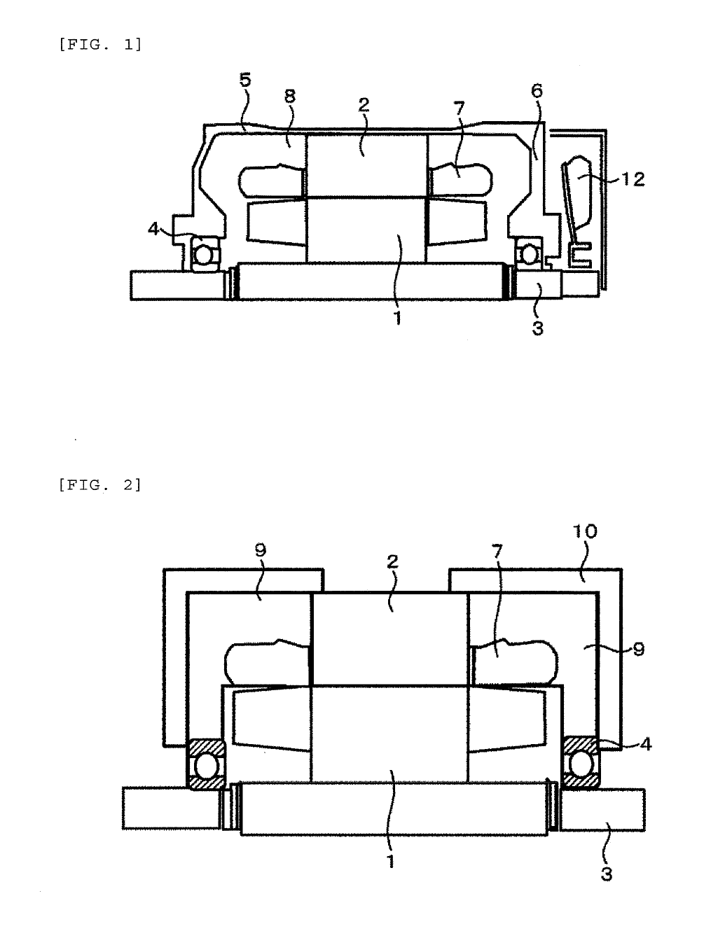

Hereinafter, an example of the invention will be descried using FIGS. 1 to 7, FIGS. 9 to 11 and FIG. 12. It should be noted that the following drawings are schematic and that the relation between thickness and dimensions in plans, the proportion of the thicknesses of respective layers and the like are different from real. Therefore, specific thicknesses and dimensions should be determined, taking the following description into consideration. Also, as a matter of course, the drawings include parts with different dimensional relations and proportions from each other.

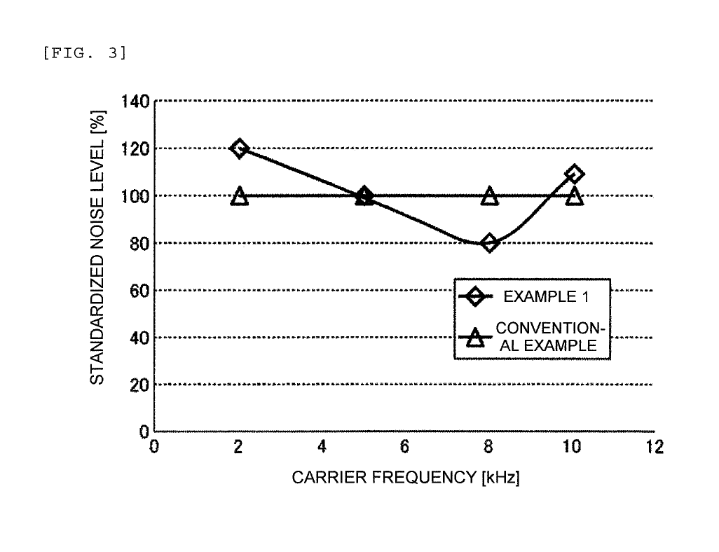

FIG. 2 is a sectional view of a rotating machine according to an embodiment of the invention. This embodiment has the structure of FIG. 1 showing the conventional embodiment from which the frame 5 and the end bracket 6 are removed and in which the periphery of the stator winding 7 is molded with a resin 9 and an end bracket 6 is molded with the resin 9.

In the conventional rotating machine, the space between the stator winding 7 and the frame 5 and the end bracket 6 is insulated by the space insulation 8, as shown in FIG. 1. As a result, according to this embodiment, molding the stator winding 7 with the resin 9 enables reduction in the space insulation 8 and thus enables reduction in size of the rotating machine.

Moreover, in this embodiment, since the frame 5 or the end bracket 6 previously made of a metal material is made of the resin in large part, the carrier frequency to noise characteristic of a resin-made inverter drive motor changes, compared with the carrier frequency to noise characteristic according to the convention example, for example, as shown in FIG. 3. Therefore, as the machine is driven at a carrier frequency which lowers noise, lower noise can be achieved.

In addition, the resin 9 of the end bracket 6 and on the periphery of the stator winding 7 is molded in one-step molding. As a result, the number of components is reduced, contributing to reduction in weight as well . Also, since there is no contact surface of the resin 9, contact heat resistance is reduced, which is thermally advantageous.

Also, in the embodiment of FIG. 2, since the coefficient of thermal expansion of resin is generally higher than that of metal, the difference in thermal expansion from the metal material used in the rotating machine tends to cause cracks in the resin 9.

For this reason, it is desirable to add a large amount of filler such as silica or alumina to the resin 9. As a result, the coefficient of thermal expansion of the resin 9 can be reduced to approximately the same level as metal. Since heat stress is reduced, generation of cracks in the resin 9 can be restrained.

Furthermore, in the above embodiment, a highly thermally conductive material 10 is provided in contact with the surface of the resin 9, as shown in FIG. 2. The highly thermally conductive material 10 is also provided in contact with a part of the stator 2 and a part of the bearing 4. As a result, not only heat is transmitted from the portion of the resin 9 to the highly thermally conductive material 10, but also more heat can be transmitted to the highly thermally conductive material 10 because the material 10 is directly in contact with the stator 2 and the bearing 4, which are heat generating parts.

Also, in the above embodiment, a radiation portion 11 as an installation pedestal is provided in a lower part of the rotating machine and a part of the highly thermally conductive material 10 is arranged in contact with the radiation portion 11. In the conventional rotating machine shown in FIG. 1, a part of heat generated in the rotating machine is sent and radiated to the radiation portion 11 such as the flange and installation pedestal for fixing the rotating machine, via the frame 5 and the end bracket 6 that are made of a metal material.

Therefore, also in this embodiment, a radiation path from the stator 2 and the bearing 4, which are heat generating parts, to the radiation portion 11 via the highly thermally conductive material 10 is formed. Thus, even in the rotating machine where a resin is applied to the stator winding 7 and the end bracket 6 is molded with the resin 9, excessive temperature rise can be restrained.

According to the above embodiment, even when the position where the highly thermally conductive material 10 is attached is not only the installation pedestal but also the radiation portion 11 such as a flange that supports the rotating machine, a heat flow speed is generated in a place where temperature is lower than the rotating machine temperature. Therefore, the effects of this example can be achieved.

Moreover, contact with a member which promotes radiation, for example, a heat sink, other than the radiation portion 11 or an equivalent place, can achieve the effects of this example further.

FIG. 4 is a sectional view of the rotating machine in the above embodiment, as viewed from an end in the axial direction. In this embodiment, a fan 12 to promote radiation to the radiation portion is provided, thus achieving the effects of this example further. In this example, heat generated in the rotating machine is guided to the radiation portion actively and intensively by the highly thermally conductive material 10.

Therefore, by locally cooling the radiation portion, the entire rotating machine can be cooled. As the fan 12 for locally cooling the radiation portion, a very small-sized and low-output fan is sufficient. Even a small-sized fan 12 can achieve sufficient effects. Thus, the temperature lowering effect according to this example can be achieved while increase in physical size due to the installation of a cooling element in the rotating machine molded with the resin 9 is minimized.

Moreover, the highly thermally conductive material 10 in the above embodiment may be a sheet-like material and the sheet-like material may be bonded or applied to the surface of the resin 9, the stator 2 and the bearing 4. In the case where the highly thermally conductive material 10 is of a sheet-like material, increase in the physical size of the rotating machine due to the bonding of the sheet can be minimized. Therefore, a smaller-sized rotating machine can be provided while temperature rise in the rotating machine is restrained.

It is more preferable that the highly thermally conductive material 10 is of a sheet-like material containing carbon graphite (hereinafter, graphite sheet). As a graphite sheet, there is a product with a thermal conductivity of about 1000 W/mK in the direction of sheet plane, which is an extremely high thermal conductivity.

Also, a graphite sheet is relatively flexible and can be deformed along a local surface shape of the exterior of the rotating machine. A graphite sheet is thin and light and enables reduction in the weight and physical size of the rotating machine main body and significant improvement in radiation performance, compared with the case where a metal plate is used. Moreover, a graphite sheet has a noise shielding effect and therefore can shut off electromagnetic waves from inside the rotating machine.

In bonding the rotating machine and a graphite sheet, it is desirable that the graphite sheet is bonded on the resin surface under sufficient bonding pressure or without any gap in-between. If sufficient bonding cannot be achieved, it is desirable that the graphite sheet is bonded with an adhesive with low heat resistance. As a result, heat generated from the rotating machine is efficiently transmitted to the graphite sheet and more heat can be transmitted to the highly thermally conductive material 10.

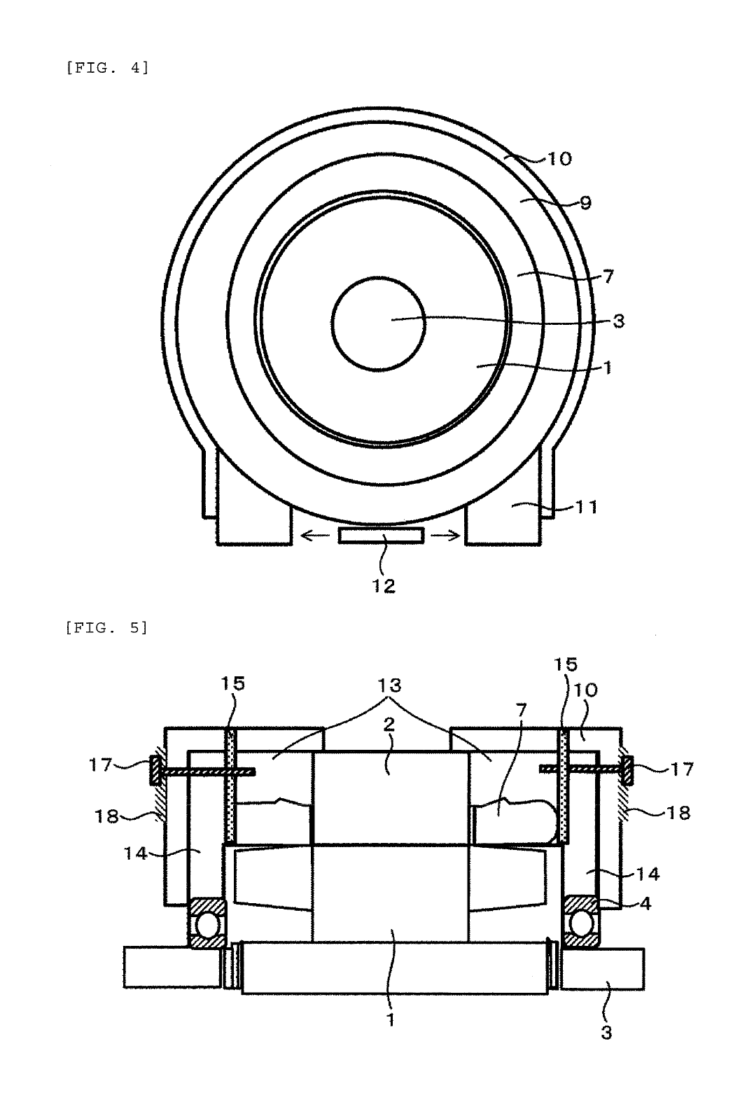

In FIG. 5, first, a mold resin 13 is molded on the inner side of the motor. After the mold resin 13 is molded, a gap material 19 is formed in a gap 15. After that, a mold resin 14 is molded on the outer side of the motor.

The gap material 19 within the gap 15 in FIG. 5 is made of a material with a higher thermal conductivity and a smaller Young's modulus than the mold resin 13 and the mold resin 14. The shape of the material formed in this gap will be described, using FIGS. 7 to 10. Since the gap material 19 has a smaller Young's modulus than the resins, generation of cracks in the resins caused when the resins expand due to the heat generated from the molded motor coil or the resins contract due to the cooling when the motor is stopped, is restrained. Moreover, since the material inserted in the gap has a high thermal conductivity and is connected to the highly thermally conductive material 10 on the outside, cooling performance with respect to the heat generated from the motor coil part is enhanced.

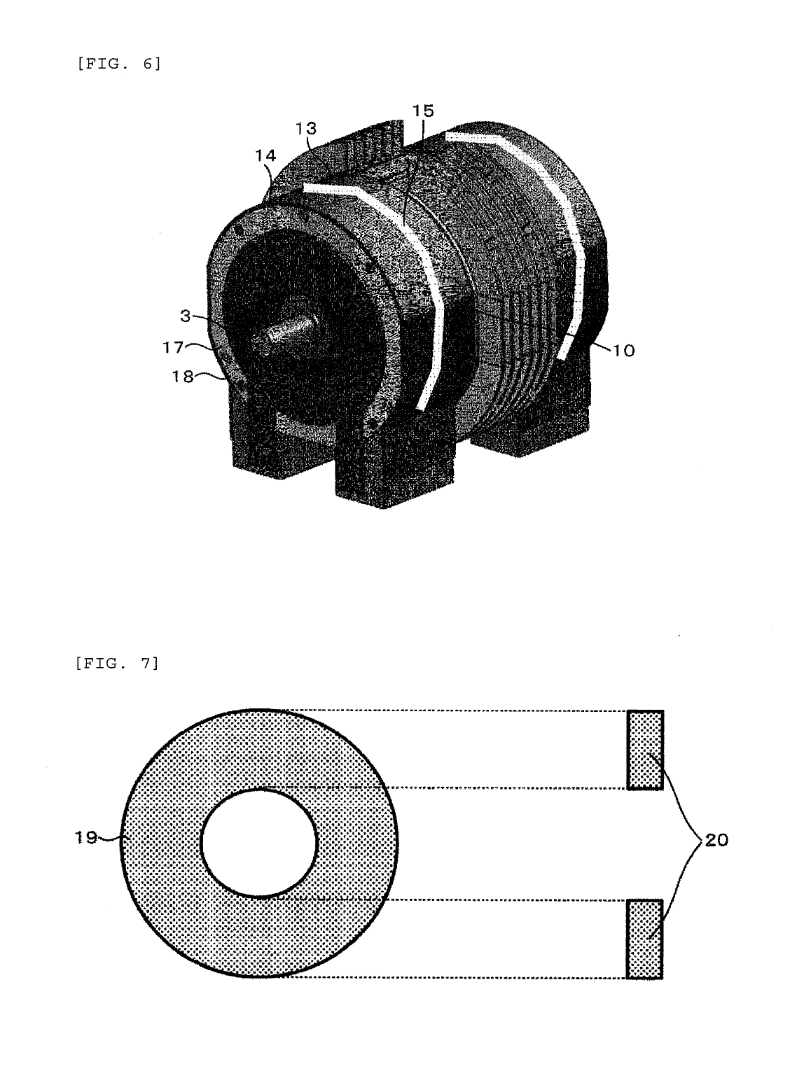

By the way, by molding the portion contacting the motor coil with the same resin, instead of providing the gap material in this portion, as shown in FIGS. 5, 8, and 10, the characteristic of the resistance against insulation breakdown in the portion contacting the motor coil can be maintained. In order to stably couple the mold resin 13 and the mold resin 14 of FIG. 5, it is desirable to fasten the resins mechanically with a screw 17 on a screw fastening plate 18 in FIGS. 5 and 6.

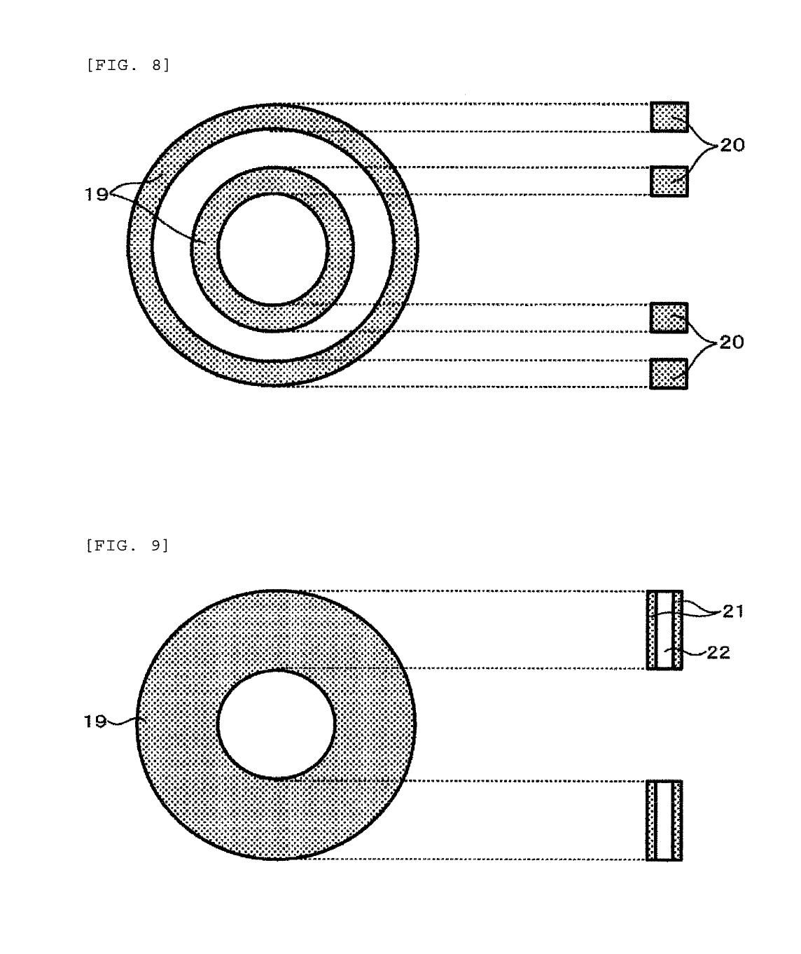

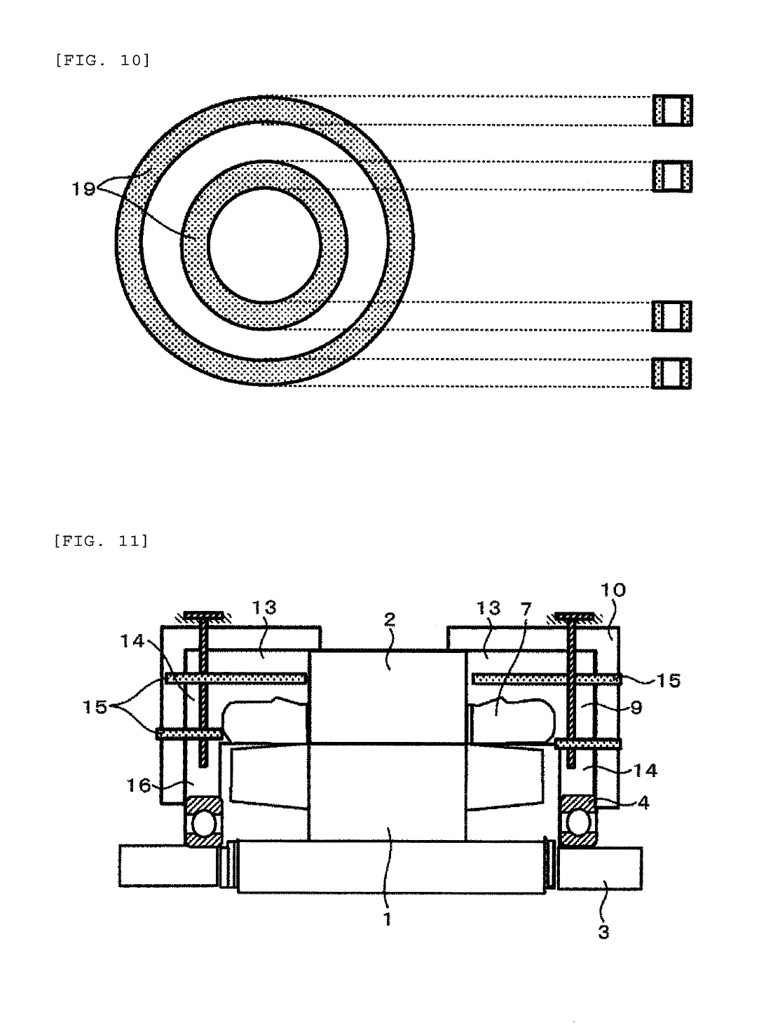

By providing a material 20 that is adhesive to the resin on both sides in FIGS. 7 and 8, adhesiveness to the resin can be improved. Specifically, a material containing elastomer such as silicone as a principal component is desirable. Moreover, in order to improve the stress relaxation characteristic, it is desirable that a highly fluid material 22 is sandwiched between adhesive materials 21, as shown in FIGS. 9 and 10. Also, it is desirable that the fluid material 22 contains a highly thermally conductive component of the gap material 19 such as graphite sheet or graphene.

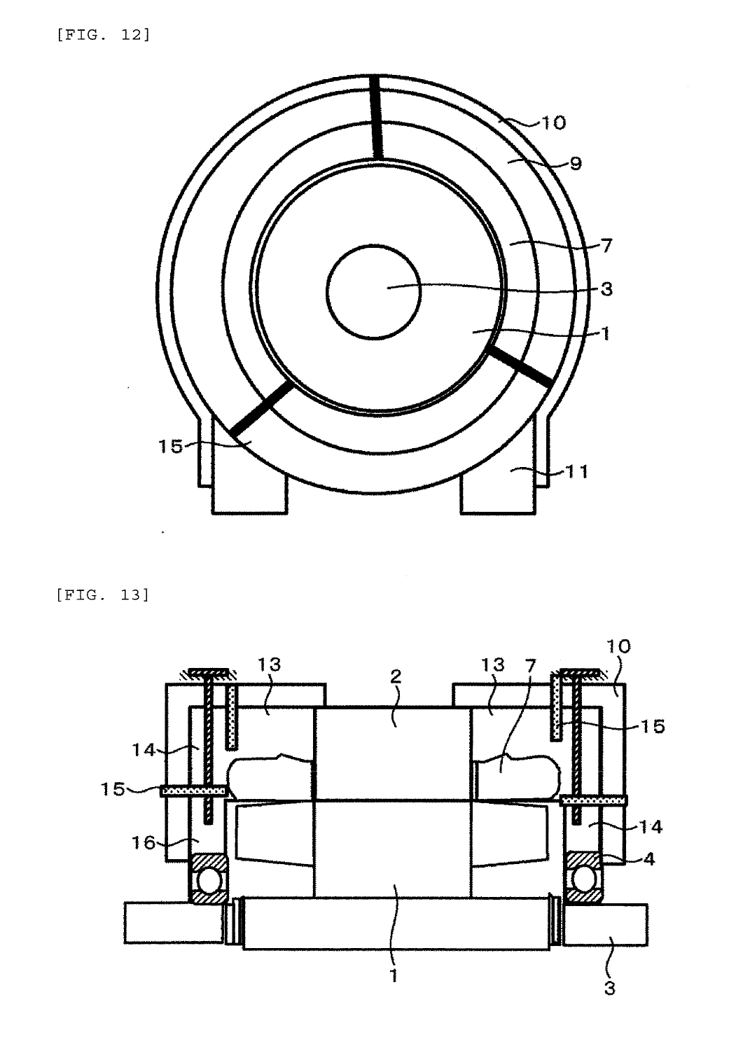

As other resin splitting methods than FIG. 5, a method in which the resin is split into three in a direction horizontal to the axis as shown in FIG. 11 and a method in which the resin is split into three in a direction perpendicular to the axis as shown in FIG. 12 are desirable.

### EXAMPLE 2

Hereinafter, a second example of the invention will be described using FIGS. 1, 4, 5, 8, and 9.

This example has the structure of the rotating machine according to the conventional embodiment shown in FIG. 1 from which the frame 5 and the end bracket 6 are removed and in which the periphery of the stator winding 7 is molded with the resin 9 and an end bracket is molded with the resin 9. A large amount of silica and alumina fillers is added to the resin 9 so that the coefficient of thermal expansion coincides with the component material of the core of the stator 2 for the purpose of restraining generation of cracks due to heat stress.

Moreover, a graphite sheet 101 provided with a coating material on a surface opposite to a resin adhesive surface is bonded to an outer circumferential portion of the rotating machine and the end in the axial direction, and a part of the graphite sheet 101 is bonded to apart of the core of the stator 2, the bearing 4, and four radiation portions 11 as installation portions. Moreover, the fan 12 made of aluminum is provided in the circumferential direction on the stator 2 that is exposed. The place where the fan 12 is installed is coated with a radiating gel for the purpose of reducing contact heat resistance with respect to the stator 2.

Here, as the adhesive material 21 in FIGS. 9 and 10, a 100-μm double-side adhesive member containing silicone as a principal component is selected. The fluid material 22 is incorporated between the adhesive materials 21 in FIGS. 9 and 10. As the fluid material 22, a gel material with a higher thermal conductivity and higher radiation performance than the resin is selected. Also, the gap material 19 is thermally connected to the graphite sheet 101 on the outer side, as shown in FIGS. 5 and 6. Moreover, the gap material 19 is not in contact with the coil part, as shown in FIGS. 5, 7, and 8.

Then, after molding with the resin 14, the mold resins 13, 14 are fastened from both sides, utilizing the screw 17 and the screw fastening plate 18, as shown in FIGS. 5 and 6. The screw needs to reach the position of the mold resin 13.

Thus, the radiation performance and stress relaxation characteristic of the mold resins 13, 14 can be improved while the characteristic of the resistance against insulation breakdown is maintained. Therefore, stress concentration at the time of thermal expansion and contraction due to cooling can be reduced and generation of cracks can be restrained.

According to a heat stress simulation, the maximum stress in the structure of FIG. 5 is ⅓ or less, compared with the conventional structure of FIG. 1.

### EXAMPLE 3

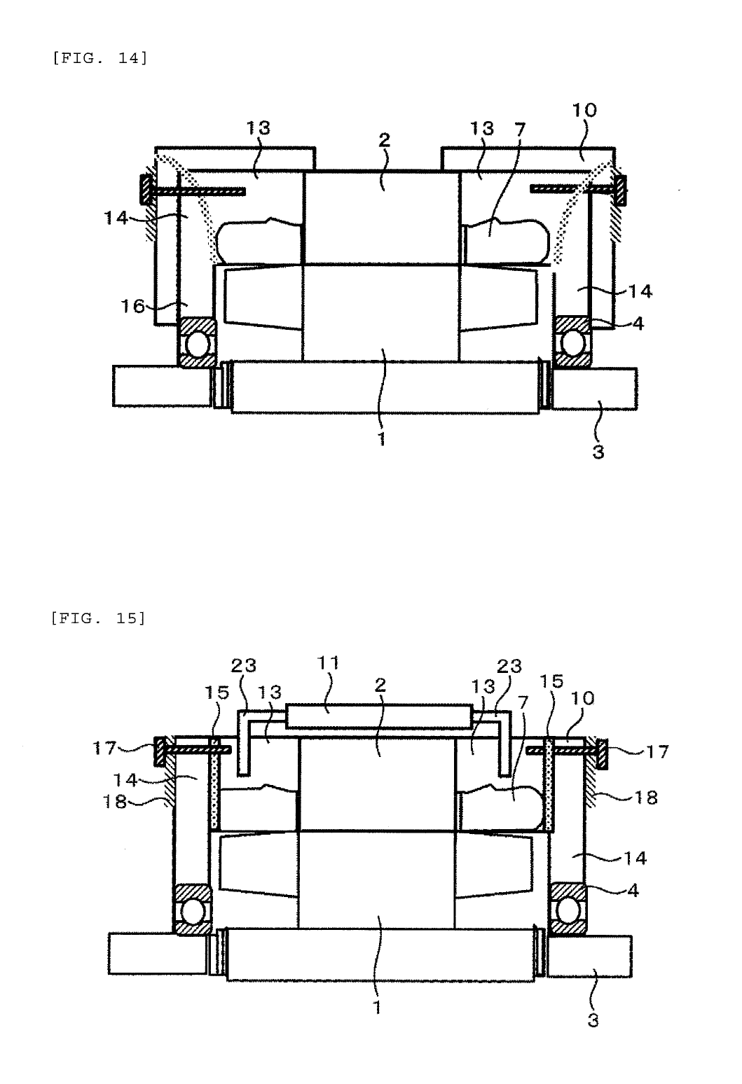

Hereinafter, a third example of the invention will be described using FIGS. 13 and 14.

In this example, a resin is molded in such a way that a gap is formed in a lateral direction as shown in FIG. 11. Here, the motor coil and the gap material are not in contact with each other. The shape of the gap material can be the shape shown in FIG. 13, the combination of FIGS. 5 and 11, or the shape as shown in FIG. 14. Moreover, combinations of all the split shapes described in Examples 1 and 2 including FIG. 10 are possible.

Here, since all the gap paths are connected to the highly thermally conductive resin 10, radiation performance increases, compared with Example 1. Therefore, generation of cracks can be restrained further.

### EXAMPLE 4

Hereinafter, a fourth example of the invention will be described using FIGS. 9 and 10.

In this example, the fluid material 22 in FIGS. 9 and 10 is made of elastomer, graphite, graphene, or two or more of these. Here, since elastomer has a smaller Young's modulus than resin, stress concentration is restrained. Graphite and graphene has a high thermal conductivity and therefore has an effect of increasing radiation performance.

### EXAMPLE 5

Hereinafter, a fifth example of the invention will be described using FIG. 5, FIGS. 11 to 13 and FIG. 14.

In this example, the mold resins 13, 14, 16 in FIG. 5 are molded and dismantled in a separate place and then incorporated into the motor. Alternatively, after the entire unit is molded, a part of the resin is cut out and a gap material is inserted. In any case, it is easy to assemble.

### EXAMPLE 6

Hereinafter, a sixth example of the invention will be described using FIG. 5, FIGS. 11 to 13 and FIG. 14.

In this example, if the maximum outer diameter of a part or the whole of the filler added to the mold resin materials 13, 14 in FIGS. 11 to 14 is 100 nm or smaller, the strength of the mold resins themselves can be improved. Therefore, generation of cracks in the mold resins can be restrained.

### EXAMPLE 7

Hereinafter, a seventh example of the invention will be described using FIG. 5.

In this example, as shown in FIG. 5, a stator in a rotating machine, a stator winding provided on the stator are consisted, and a rotating machine in which a part or the whole of the stator and the stator winding is molded with a resin, thereby insulating the stator winding, are considered.

Here, carbon graphite is provided inside or outside the resin. The carbon graphite, and a radiation portion connected to a cooling portion made up of a fan outside the resin are connected to each other. Carbon graphite is also applied to apart or the while of the outside of the stator. Thus, cooling performance can be enhanced.

### EXAMPLE 8

Hereinafter, an eighth example of the invention will be described using FIG. 15.

In this example, as shown in FIG. 15, a stator in a rotating machine, a stator winding provided on the stator, and a rotating machine in which a part or the whole of the stator and the stator winding is molded with a resin, thereby insulating the stator winding, are considered.

Here, a heat pipe is provided inside or outside the resin. The heat pipe, and a radiation portion connected to a cooling portion made up of a fan outside the resin are connected to each other. Thus cooling performance can be enhanced.

### REFERENCE SIGNS LIST

1 rotor, 2 stator, 3 rotation axis, 4 bearing, 5 frame, 6 end bracket, 7 stator winding, 8 space insulation, 9 resin, 10 highly thermally conductive material, 11 radiation portion, 12 fan, 13, 14, 16 mold resin, 15 gap, 17 screw, 18 screw fastening plate, 19 gap material, 20 material having double-side adhesive property and a higher thermal conductivity and a lower Young's modulus than mold resin, 21 adhesive material, 22 fluid material, 23 heat pipe, 101 graphite sheet

1. A resin-molded electrical rotating machine, characterized in that
a part or the whole of a gap between at least two mold resins molded in different places from each other is made of a material with a higher thermal conductivity and a lower Young's modulus than the mold resins, and the mold resins are bonded together mechanically or with an adhesive material.

2. The resin-molded electrical rotating machine according to claim 1, characterized in that
apart or the whole of an outer circumference of a motor is made of a material with a higher thermal conductivity than the mold resins and made to contact with the material inside the gap.

3. The resin-molded electrical rotating machine according to claim 1, characterized in that
one side or both sides of the material in the gap is made of a material that is adhesive to the mold resins.

4. The resin-molded electrical rotating machine according to claim 1, characterized in that
the material in the gap is made up of a fluid material.

5. The resin-molded electrical rotating machine according to claim 1, characterized in that
the material in the gap has silicone as a component.

6. The resin-molded electrical rotating machine according to claim 1, characterized in that
the material in the gap has elastomer as a component.

7. The resin-molded electrical rotating machine according to claim 1, characterized in that
the material in the gap has a graphite sheet or graphene as a component.

8. The resin-molded electrical rotating machine according to claim 1, characterized in that
the resin is manufactured by cutting a resin that is produced by one-step molding.

9. The resin-molded electrical rotating machine according to claim 1, characterized in that
the resin is manufactured with a crack carved in a surface of the resin.

10. The resin-molded electrical rotating machine according to claim 1, characterized in that
a screw is fastened from outside a motor in a direction at right angles to a splitting direction.

11. The resin-molded electrical rotating machine according to claim 1, characterized in that a filler added to the material within the mold resin has a maximum outer diameter of 100 nm or smaller.

12. The resin-molded electrical rotating machine according to claim 1, characterized in that
a stator,
a stator winding provided on the stator,
a part and the whole of the stator and the stator winding are molded with a resin, thus insulating the stator winding,
a material transmitting heat to outside via a shift in the quantity of heat due to change in state of a heat pipe or a material is provided inside or outside the resin, and
the heat pipe or the material is connected to a radiation portion provided outside the resin.

13. The resin-molded electrical rotating machine according to claim 1, characterized in that
a stator,
a stator winding provided on the stator,
a part and the whole of the stator and the stator winding are molded with a resin, thus insulating the stator winding,
carbon graphite is provided inside or outside the resin,
the carbon graphite and a radiation portion provided outside the resin are connected to each other,
the radiation portion is connected to a cooling portion made up of a fan, and
carbon graphite is applied to a part or the whole of the outside of the stator.

14. A resin-molded electrical rotating machine that is molded with a resin, characterized in that
a portion between at least two mold resins is made of a material with a higher thermal conductivity and a lower Young's modulus than the resins, and the resins are bonded together mechanically or with an adhesive material.
